(19) United States
(12) Patent Application Publication
(10) Pub. No.: US 2026/0136078 A1
(43) Pub. Date: May 14, 2026

(54) THREE-DIMENSIONAL GROUNDED VIDEO GENERATION

(71) Applicant: NVIDIA Corporation, Santa Clara, CA (US)

(72) Inventors: Jun Gao, North York (CA); Sanja Fidler, Toronto (CA); Xuanchi Ren, Toronto (CA); Tianchang Shen, Markham (CA); Jiahui Huang, Santa Clara, CA (US); Huan Ling, Toronto (CA); Thomas Müller-Höhne, Baar (CH); Merlin Nimier-David, Nyon (CH); Alexander Georg Keller, Berlin (DE); Yifan Lu, Kirkland, WA (US)

(21) Appl. No.: 19/277,629

(22) Filed: Jul. 23, 2025

Related U.S. Application Data
(60) Provisional application No. 63/720,483, filed on Nov. 14, 2024.

(51) Int. Cl. H04N 21/81; G06T 5/70; H04N 19/172; H04N 21/431

(52) U.S. Cl. CPC H04N 21/816; G06T 5/70; H04N 19/172; H04N 21/4318

(57) ABSTRACT

Systems and methods are disclosed related to a 3D grounded video foundation model. A video generation method and system provide 3D conditioning information to a video diffusion model to improve generated video quality (object and temporal consistency) that is grounded in three dimensions (3D). The video generation method and system also enable precise camera control, cinematic effects, and scene editing. Video output corresponding to a set of camera specifications is generated for a scene from input image(s) including one or more images of a static scene or a sequence of images (video) for a dynamic scene. The input image(s) are used to calculate a 3D cache representing the scene. The 3D cache is rendered according to the set of camera specifications to produce a frame sequence and a mask sequence that identifies missing pixels in each frame. The frame sequence is encoded and masked to generate the output video.

### CLAIM OF PRIORITY

This application claims the benefit of U.S. Provisional Application No. 63/720,483 (Attorney Docket No. 515140) titled “3D Grounded Video Model,” filed Nov. 14, 2024, the entire contents of which is incorporated herein by reference.

### BACKGROUND

Generative video models process a single image or a sequence of images (video) to produce a realistic output video. Conventional generative video models do not always produce consistent output, in particular object permanence is not always maintained. For example, returning to a location in a (static) scene should produce an image consistent with prior visits to the location and its vicinity. Similarly, returning to the same camera pose in a video (static scene) should produce the same image. Additionally, conventional generative video models provide limited (if any) user control for scene manipulation, specifying a camera trajectory, object editing, and the like. There is a need for addressing these issues and/or other issues associated with the prior art.

### BRIEF DESCRIPTION OF THE DRAWINGS

The present systems and methods for a three dimensional (3D) grounded video generation are described in detail below with reference to the attached drawing figures, wherein:

FIG. 1A illustrates a block diagram of an example video generation system, according to an embodiment.

FIG. 1B illustrates a block diagram of an example 3D cache computation unit, according to an embodiment.

FIG. 1C illustrates a flowchart of a method for computing the 3D cache, according to an embodiment.

FIG. 2A illustrates a block diagram of an example single view input video generation system, according to an embodiment.

FIG. 2B illustrates a flowchart of a method for generating a video from a single view input, according to an embodiment.

FIG. 2C illustrates a block diagram of an example training configuration, according to an embodiment.

FIG. 3A illustrates a block diagram of an example multiple view input video generation system, according to an embodiment.

FIG. 3B illustrates a block diagram of an example multiple view latent fusing unit, according to an embodiment.

FIG. 3C illustrates a flowchart of a method for generating a video from multiple view inputs, according to an embodiment.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Systems and methods are disclosed related to systems and methods for generating and manipulating video content using a 3D grounded video foundation model. A video generation method and system provide 3D conditioning information to a video diffusion model to improve generated video quality (object and temporal consistency) that is grounded in 3D. The video generation method and system also enable precise camera control, cinematic effects, and scene editing. The video generation method and system may be applicable to various domains such as entertainment, virtual reality, augmented reality, robotics, and autonomous vehicle simulation. Use cases may include, but are not limited to, virtual reality, augmented reality, novel view synthesis, video editing, cinematic effects generation, scene manipulation, robotics manipulation, and generating autonomous vehicle training datasets.

Video output corresponding to a set of camera specifications is generated for a scene from input image(s) including one or more images of a static scene or a sequence of images (video) for a dynamic scene. The input image(s) are used to calculate a spatiotemporal 3D cache representing the scene. To generate an output video according to the set of camera specifications, the 3D cache is rendered to produce conditioning information for a video diffusion process including a frame sequence and a mask sequence that identifies missing pixels in each frame. The frame sequence is encoded and masked to generate the output video.

The systems and methods described herein may enable precise camera control, allowing users to specify desired camera trajectories for generated video output, providing enhanced capabilities for realistic and controllable video content generation and manipulation. Additionally, the 3D grounded approach facilitates consistency across generated video frames, particularly when revisiting previously observed scene locations.

In some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, image processing pipelines, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a 3D content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.”

For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in one or more embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The 3D grounded video foundation model(s) and video generation systems described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In one or more embodiments, the inference microservice may include software to perform in-place replacement and/or updating to the machine learning model(s). When replacing or updating, the software that performs the replacement/updating may maintain user configurations of the inference runtime software and enterprise management software.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

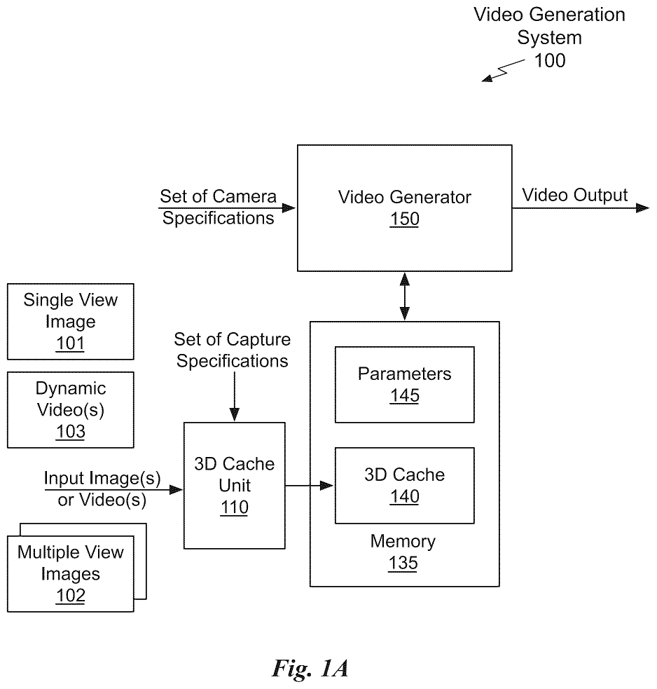

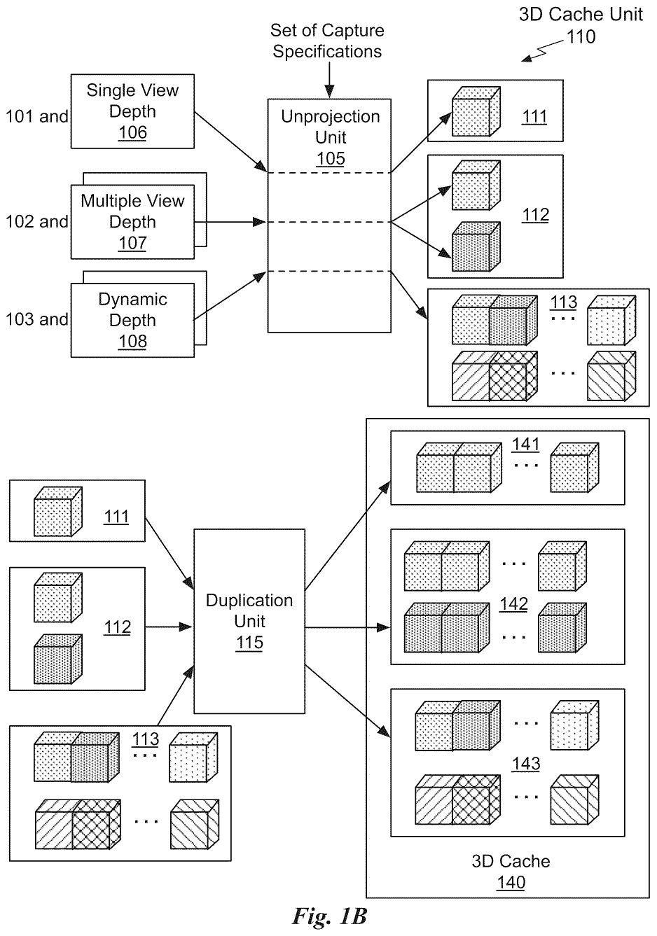

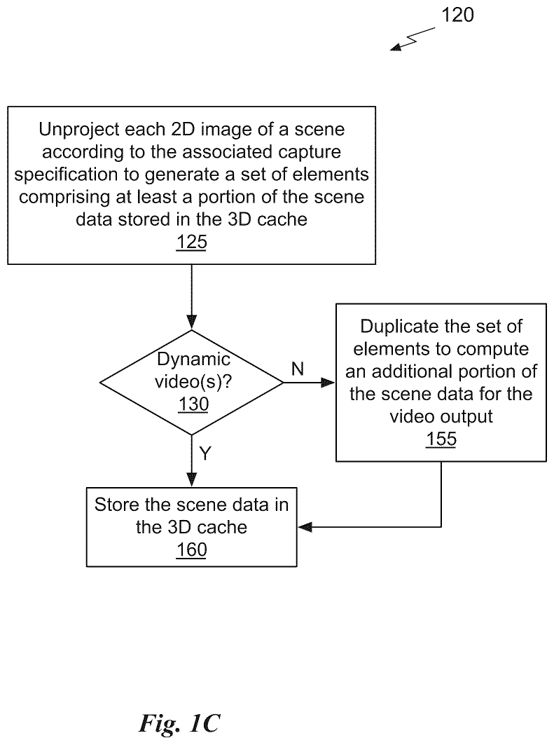

FIG. 1A illustrates a block diagram of an example video generation system 100, according to an embodiment. The video generation system 100 comprises a 3D cache (computation) unit 110, memory 135, and a video generator 150. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the video generation system 100 is within the scope and spirit of embodiments of the present disclosure.

In an embodiment, the video generator 150 comprises a pre-trained video diffusion model. A diffusion model f_{θ} learns to model a data distribution p_{data}(x) via an iterative denoising process. To train the diffusion model, noisy versions x_{τ}=α_{τ}x₀+σ_{τ}ϵ of a data sample x₀˜p_{data}(X) are constructed by adding noise E sampled from a Gaussian distribution, [symbol] (0,1), with the noise schedule parameterized by α_{τ} and σ_{τ}. The diffusion time τ is sampled from the distribution p_{τ}. Then, the parameters θ of the diffusion model f_{θ} are optimized to minimize the denoising score matching objective function:

$${𝔼}_{{x}_{0} ∼ {p}_{data} ( x ) , τ ∼ {p}_{τ ,} ε ∼ N ( 0 , I )} [ {‖ {f}_{θ} ( {x}_{τ} ; c , τ ) - y ‖}_{2}^{2} ] \qquad Eq . ( 1 )$$

where c is optional conditions, and the target y can be ϵ, α_{τ}ϵ−σ_{τ}x₀[46], or x₀[23], depending on the selected denoising process. Once trained, iteratively applying f_{θ} to a sample of Gaussian noise will produce a sample of p_{data}(X).

In diffusion-based video generation models, latent diffusion models are frequently employed to compress the video for operation in a lower-dimensional space. Specifically, given RGB video data x∈ [symbol] ^{L×3×H×W} where L is the number of frames of size H×W, a pre-trained variational autoencoder (VAE) ε will encode the video into a latent space, i.e. z=ε(x)∈ [symbol] ^{L′'C×h×w}. Training and inference of the diffusion model are performed in this latent space. The final video \hat{x}= [symbol] (z) is decoded with a pre-trained VAE decoder [symbol] . In an embodiment, the video generator 150 comprises a pre-trained Stable Video Diffusion model, which is conditioned on an image c and only compresses the video in the spatial dimension:

$${L}^{′} = L , C = 4 , h = \frac{H}{8} , and w = \frac{W}{8} .$$

However, other pre-trained video diffusion models may be used because the video generation system 100 is compatible with any other image-to-video diffusion model, as it does not rely on details of the video diffusion model architecture.

The input to the video generation system 100 is input 2D image(s) or video(s) and at least one set of camera specifications corresponding to the video output. In the context of the following description, frames of video are a sequence of 2D images. In an embodiment, the input 2D image(s) or video(s) may be provided by a user or generated by another image or video generation model. In an embodiment, the video may be sparse in terms of time or correspond to a frame rate that is not real-time. Camera specifications may include the camera pose (position and orientation) and focal length, corresponding to an output video to be generated (novel view synthesis). In an embodiment, the set of camera specifications defines a camera path for one or more frames, with each output camera specification corresponding to a frame of the output video. In an embodiment, a user provides the set of camera specifications.

In an embodiment, the input image(s) includes at least one input image comprising a single view image 101 of a static scene corresponding to a set of (camera) capture specifications, where the set includes one camera specifications. In an embodiment, the input image(s) comprises multiple view (multi view) images 102 including two or more input images of a static scene corresponding to two or more different sets of capture specifications. In an embodiment, the video(s) comprise dynamic video(s) 103, where each video includes a sequence of two or more single view images of a dynamic scene corresponding to two or more sets of capture specifications. The camera specification corresponding to each input image may be known or derived from the input image. In an embodiment, the videos comprise dynamic multi view images such as at least two time-synchronized videos of the same dynamic scene, where each video corresponds to different sets of capture specifications.

The video generation system 100 may include a memory 135 for storing data used in the video generation process. In some cases, the memory 135 may contain a 3D cache 140 and parameters 145. The 3D cache 140 may comprise a spatiotemporal representation of scene data derived from the input image(s) or video(s). In an embodiment, the 3D cache 140 includes a colored point cloud for each input image, allowing the video generation system 100 to maintain a 3D representation of the scene. When the 3D cache 140 includes scene data computed for multiple view images 102, the video generator 150 may combine information from different viewpoints (camera poses) to create more accurate video output.

Scene data that is stored in the 3D cache 140 is computed using the input image(s) or video(s) and the set of capture specifications. After the scene data is available in the 3D cache 140, the 3D cache 140 may be rendered by the video generator 150 into the camera plane according to the set of camera specifications that may be provided by the user. Such rendered images, while imperfect, provide a strong condition for the video generator 150 on the visual content that is generated. In addition to the rendered images, the video generator 150 uses parameters 145, such as weights to generate the video output. At least a portion of the parameters 145 may be initialized to values associated with a pre-trained video diffusion model within the video generator 150. In an embodiment, at least a portion of the parameters 145 used by the video generator 150 is fine-tuned accordingly to produce a 3D-consistent output video that precisely aligns with the desired camera specifications.

In an embodiment, the input image(s) and video(s) are no longer needed after the scene data is computed and stored in the 3D cache 140. However, as described further herein, the scene data may be edited and/or additional scene data may be computed using frame(s) of the video output and corresponding camera specifications. The 3D cache 140 provides guidance to inform video generation, enabling precise camera control according to the set of camera specifications and improved consistency across the video frames. The video generation system 100 may render new viewpoints, create dynamic scenes, or manipulate existing content based on the 3D scene representation stored in the 3D cache 140.

FIG. 1B illustrates a block diagram of an example 3D cache (computation) unit 110, according to an embodiment. The 3D cache unit 110 comprises an unprojection unit 105 and a duplication unit 115. Choosing a representation of the scene data that is compatible with different applications and that generalizes to different scenes is a main consideration when computing the spatiotemporal 3D cache 140. The 3D cache data may comprise light detection and ranging (LIDAR) data, position (x,y,z), depth, color, features, such as normal vectors and/or features output by pretrained models, such as at least one of distillation no labels (DINO) and contrastive language-image pre-training (CLIP).

Techniques for estimating depth have progressed for images progress across various domains, such as indoor, outdoor, or self-driving scenes. Single view depth 106, multiple view depth 107, and/or dynamic depth 108 may be estimated using images and/or the capture specifications for each of the single view image 101, multiple view images 102, and dynamic videos 103, respectively. The capture specifications may be estimated using images. Unless provided, the depth information and/or capture specifications required for unprojection may be inferred or estimated using conventional techniques.

In an embodiment, the spatiotemporal 3D cache 140 comprises a colored point cloud for each input image. In an embodiment, the spatiotemporal 3D cache 140 comprises colored 3D Gaussian splats for each input image. In an embodiment, the spatiotemporal 3D cache 140 comprises LIDAR point cloud for each input image. The unprojection unit 105 computes the colored point cloud by unprojecting from the depth estimation of an RGB image. Specifically, for an RGB image seen from a camera capture viewpoint v at time t, a point cloud, P^{t,v}, is computed by unprojecting the depth estimation of the RGB image. The number of image views captured by camera viewpoint(s) (capture specifications) is V, and the length in temporal dimension is L; thus, the 3D cache 140 is an L×V array of point clouds. For the single view image 101, L=V=1. For the multiple view images 102, L≥1 and V≥2. For the dynamic video(s) 103, L>1 and V≥1. As shown in FIG. 1B, V=2 for the dynamic videos 103 and dynamic depth 108. The unprojection unit 105 computes a set of elements 111, 112, or 113 corresponding to the single view image 101, multiple view images 102, or dynamic videos 103, respectively. In an embodiment, each set of elements comprises L*V point clouds. In one embodiment, the point clouds may be at least one of refined and post-processed to improve their alignment. In an embodiment, the post-processing includes by minimizing the reprojection error by aligning the depth estimations of frames with the scene data in the 3D cache 140.

The spatiotemporal 3D cache 140 may be computed according to the specific downstream applications. For static novel view synthesis (NVS), one element is computed for each of the time-synchronized V images, and the one element is duplicated L times along the temporal dimension. Specifically, for single image to video generation, the one element in the set of elements 111 is computed by the unprojection unit 105, and the set of elements 111 is duplicated L times along the temporal dimension by the duplication unit 115 to generate scene data 141 corresponding to the video output of length L. For multiple view images to video generation, the V elements in the set of elements 112 are computed by the unprojection unit 105, and the set of elements 112 is duplicated L times along the temporal dimension by the duplication unit 115 to generate scene data 142 corresponding to the video output of length L.

For dynamic images, the 3D cache data for each input image is stored in the 3D cache 140 without duplication in L. For dynamic multiple view images to video generation, the unprojection unit 105 computes a number of elements in the set of elements 112 that equals the number of frames (F) in each time-synchronized dynamic video for each of V input dynamic video(s) 103, and the duplication unit 115 simply passes the set of elements through to generate scene data 142 corresponding to the video output of length L. Note that although F may equal L, F does not need to equal L. V equals to the number of time-synchronized videos, and both single view and multi view dynamic NVS may be performed by the video generation system 100. In an embodiment, the set of elements is not duplicated in the 3D cache 140 and is instead read out of the 3D cache 140 multiple times to effectively provide scene data including a duplicated set of elements 111 or 112. The scene data in the computed 3D cache 140 may be simulated and/or edited to modify the scene, for example, by removing or adding objects.

FIG. 1C illustrates a flowchart of a method 120 for computing the 3D cache 140, according to an embodiment. Each block of method 120, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 120 is described, by way of example, with respect to the video generation system 100 and the 3D cache unit 110 of FIGS. 1A and 1B, respectively. However, this method may additionally or alternatively be executed by any one system, or any combination of systems, including, but not limited to, those described herein. Furthermore, persons of ordinary skill in the art will understand that any system that performs method 120 is within the scope and spirit of embodiments of the present disclosure.

At step 125, each 2D image of a scene is unprojected according to the associated capture specification to generate a set of elements comprising at least a portion of the scene data stored in the 3D cache 140. At step 130, the duplication unit 115 determines if the input is dynamic video(s) 103, and, if not the input is either a single view image 101 or multi view images 102, and, at step 155, the set of elements is duplicated to compute an additional portion of the scene data for the video output before proceeding to step 170. In an embodiment, the portion of the scene data is duplicated to produce scene data including L*V elements. At step 160, the scene data is stored in the 3D cache 140.

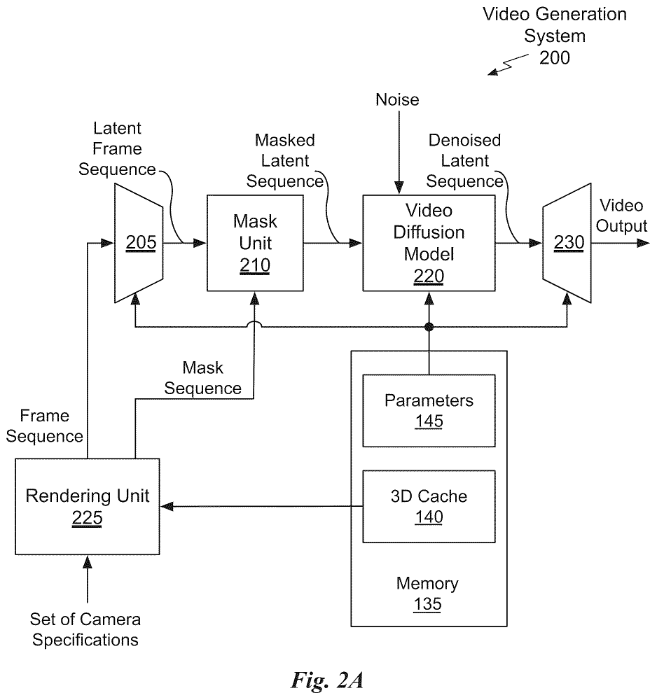

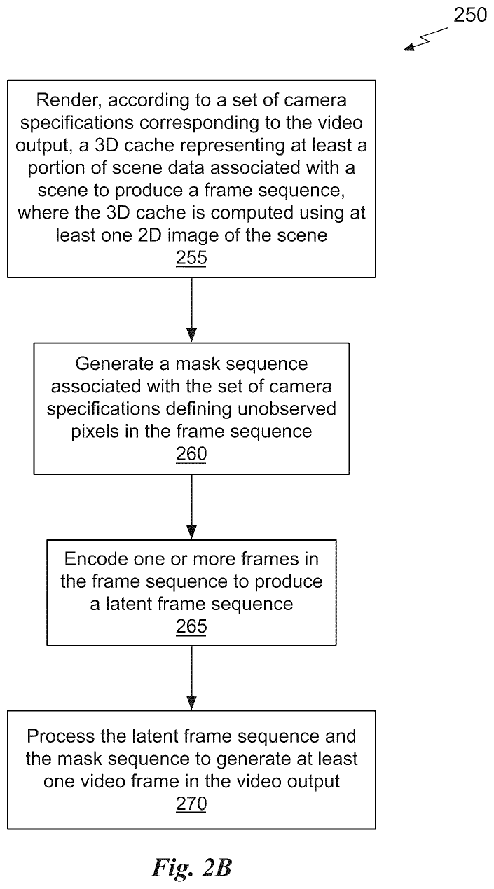

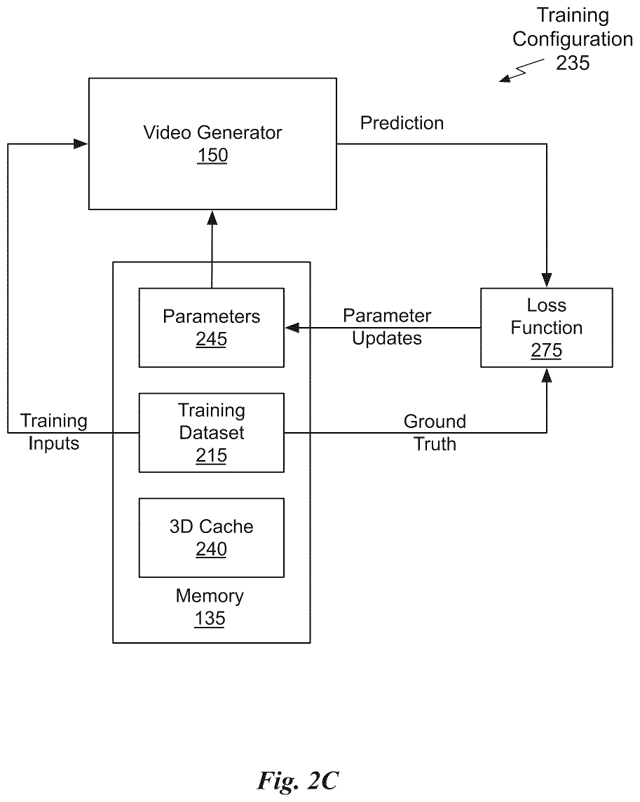

FIG. 2A illustrates a block diagram of an example single view (V=1) input video generation system 200, according to an embodiment. The video generation system 200 comprises the memory 135, a rendering unit 225, an encoder 205, a mask unit 210, a video diffusion model 220, and a decoder 230. In an embodiment, the video generator 150 comprises a pre-trained video foundation model, such as a diffusion model. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the video generation system 100 is within the scope and spirit of embodiments of the present disclosure.

The input may be a single image of a static scene or single video including multiple frames of a dynamic scene. In an embodiment, a dynamic scene includes at least one object in motion (changing position or shape) and/or capture specifications that are different for at least two frames. The memory 135 stores the spatiotemporal 3D cache 140 that includes the computed scene data. The memory 135 also stores parameters 145 for the pre-trained encoder 105, video diffusion model 120, and decoder 130. The rendering unit 125 renders the 3D cache 140 using the set of camera specifications defining a camera path for the video output to produce a frame sequence and a mask sequence. In an embodiment, a mask identifies missing or unobserved pixels in each rendered frame. Pixels may be missing due to occlusion or may not be in the 3D cache 140 for example after the camera zooms out from the scene. For a particular image, the mask indicates regions of the image that are not present in the 3D cache 140 for the corresponding output camera specification. In an embodiment, each mask for a rendered frame comprises binary values or one bit per pixel that indicates whether or not the pixel is present.

Point clouds and 3D Gaussian splats can be easily and efficiently rendered along any camera trajectory. Such a rendering function [symbol] maps P^{t,v} onto a tuple: (I^{t,v},M^{t,v}):= [symbol] (P^{t,v},C^{t}), where I^{t,v} is the RGB image as observed from camera specification C^{t}. The mask M^{t,v} identifies disocclusions, flagging pixels that are not covered when rendering the scene data. In that sense, the mask identifies regions of the image I^{t,v} that need to be filled in. For a set C=(C¹, . . . , C^{L}) of set of camera specifications, the scene data P^{t,v} in the 3D cache 140 is rendered by the rendering unit 225 to obtain V videos ( [symbol] (P^{1,v},C¹), [symbol] (P^{2,v},C²), . . . , [symbol] (P^{t,v},C^{L})), where 1≤v≤V. Concatenating the rendered image sequence (I^{1,v}, . . . , I^{L,v}) and the mask sequence (M^{1,v}, . . . , M^{L,v}) along the temporal dimension for a camera specification v, the resulting sequences of the images and the masks are denoted by I^{v}∈ [symbol] ^{L×3×H×W} and M^{v}∈ [symbol] ^{L×1×H×W}, respectively.

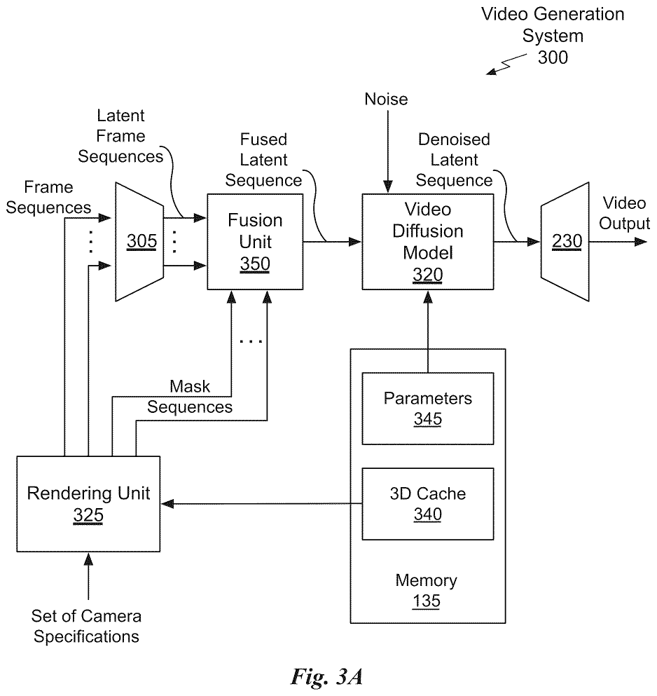

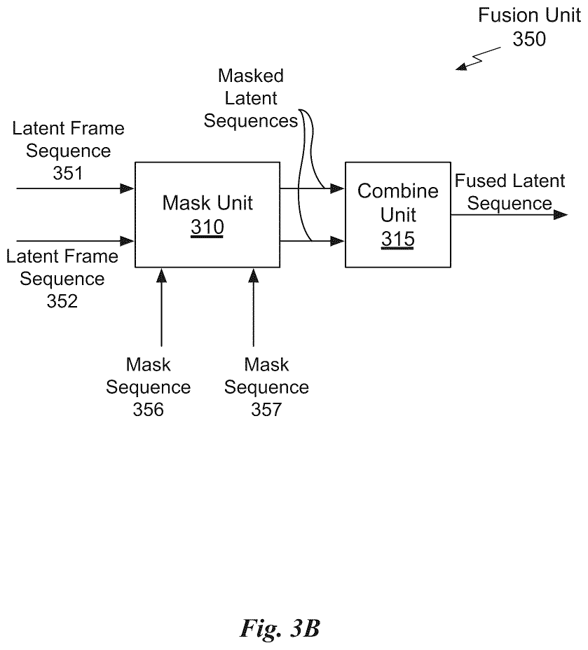

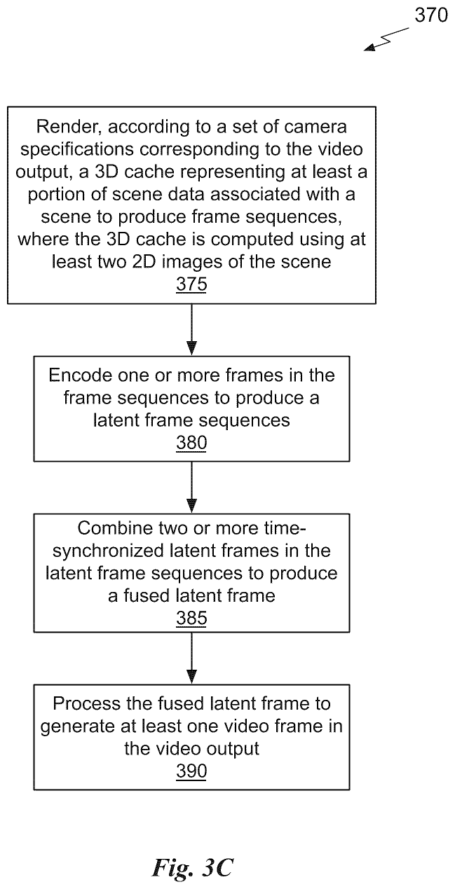

In one embodiment, when the scene is static, at least one rendered image is produced for each output video frame using the elements of the scene data stored in the 3D cache 140 corresponding to an input capture specification that is closest to the output camera specification for the output video frame. In one embodiment, for static scenes, the elements of the scene data stored in the 3D cache 140 corresponding to the K closest input capture specifications are rendered to produce K rendered images for each output video frame. In one embodiment the number K is chosen to be four. When K>1 for a static scene, the scene data corresponding to the K closest input capture specifications are processed in the same manner as V=K multiple view images, as described in conjunction with FIGS. 3A, 3B, and 3C. When the number of different (unique) capture specifications is less than K, V=the number of capture specifications. In an embodiment, V−K zero padded views (e.g., null views) are inserted so that K elements are output.

In an embodiment, for dynamic scenes, the elements of the scene data stored in the 3D cache 140 corresponding to the same time t are rendered using the output camera specification of each output video frame to produce at least one rendered image for each dynamic scene output video frame. In one embodiment, for dynamic scenes, only the static regions of the elements of the scene data stored in the 3D cache 140 are rendered after masking out dynamic regions. In another embodiment, for dynamic scenes, the elements of the scene data stored in the 3D cache 140 are aligned (synchronized) across time using scene flow prior to rendering. In the case of driving scenarios, the positions of vehicles may be adjusted during calculation of the scene data by the 3D cache unit 110 using tracking labels to align the elements of the scene data stored in the 3D cache 140 data across time.

The forward computation process of the image-to-video diffusion model 220, denoted by

$${f}_{θ}^{′}$$

is modified compared with the pre-training. Specifically, the video diffusion model 220 is conditioned on the renderings of the 3D cache 140. The rendered frame sequence, video I^{v} is encoded into latent space by the encoder 205, E, according to the parameters 145, to obtain a latent frame sequence (latent video) z^{v}=ε(I^{v})∈ [symbol] ^{L′×C×h×w}. In an embodiment, the encoder 205 comprises a VAE. The mask unit 210 masks out the regions in the latent frame sequence that are not covered by the 3D cache 140, as indicated by the mask sequence M^{v}.

Concatenating the mask sequence with the latent frame sequence to produce the masked latent sequence introduces additional model parameters, which do not generalize well to out-of-distribution masks during fine-tuning. This issue is particularly severe in driving simulations, where ground truth views for novel trajectories (e.g., horizontal shifts from the original trajectory) are unavailable. In contrast, directly multiplying the mask sequence with the latent sequence demonstrates better generalization, significantly reducing artifacts when synthesizing extreme novel views. Therefore, the mask unit 210 applies the mask sequence to the latent frame sequence (via element-wise multiplication), removing latent vectors corresponding to the missing regions in each latent frame, to produce a masked latent sequence. Directly applying the masks to the frames for input to the video diffusion model 220 requires no modifications to the architecture of the video diffusion model 220.

The masked latent sequence is combined with noise for processing by the video diffusion model 220, according to the parameters 145, to produce a denoised latent sequence. In an embodiment, the noise is Gaussian noise. Finally, the denoised latent sequence, video is decoded, according to the parameters 145, by the decoder 230 [symbol] to generate the video output \hat{x}= [symbol] (z) corresponding to the set of camera specifications. In an embodiment, the decoder 230 comprises a pre-trained VAE decoder. Fine-tuning and inference of the video diffusion model 220 are performed in the latent space. The pre-trained video diffusion model 220 is fine-tuned to process additional 3D conditioning or guidance input provided by the masked latent sequence. The video diffusion model 230 is trained to at least one of remove artifacts from the unobserved regions, complete, and inpaint unobserved regions to generate a high-quality video output while maintaining 3D consistency.

To generate long output videos, the 3D cache 140 is incrementally updated. In an embodiment, the (to be generated) output video is divided into segments with one frame overlap between segments. The first segment of the output video is generated as previously described. The 3D cache 140 is then augmented with 3D data for the last frame in the first segment (unprojected using the camera specifications for the last frame). In an embodiment, one or more additional frames in the first segment are unprojected to augment the 3D cache 140.

The augmentation captures a new viewpoint of the scene and provides additional information not available in the original 3D cache 140. In an embodiment, the unprojection unit 105 estimates the pixel-wise depth of the last frame and aligns the depth estimation with the 3D cache 140 by minimizing the reprojection error to align the last frame in the first segment with the scene data in the 3D cache 140. Specifically, the depth estimation is denoted as d and scaling s and translation t coefficients for d are optimized. The frame sequence is rendered from the 3D cache 140 into a depth image at the camera viewpoint of d, denoted as d^{tgt}, and render a mask M indicating whether each pixel is covered by the 3D cache 140. The optimization objective is then defined as:

$$s , t = arg {min}_{s , t} {‖ ( s \cdot d + t - {d}^{tgt} ) \cdot M ‖}_{2}^{2} . \qquad Eq . ( 2 )$$

The optimized s and t are applied to normalize the depth estimation d:

$${d}^{′} = s \cdot d + t . \qquad Eq . ( 3 )$$

The unprojection unit 105 unprojects d′ into a 3D point cloud using the camera specifications of the last frame and appends it to the existing scene data in the 3D cache 140. The updated 3D cache 140 is subsequently used to predict the subsequent segments of frames, ensuring that the prediction for the subsequent segments is informed by the first segment, leading to consistent generation of long videos. The process may be repeated to update the 3D cache 140 for each subsequent segment.

FIG. 2B illustrates a flowchart of a method 250 for generating a video output from a single view input, according to an embodiment. Each block of method 120, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 250 is described, by way of example, with respect to the video generation systems 100 and 200 of FIGS. 1A and 2A, respectively. However, this method may additionally or alternatively be executed by any one system, or any combination of systems, including, but not limited to, those described herein. Furthermore, persons of ordinary skill in the art will understand that any system that performs method 250 is within the scope and spirit of embodiments of the present disclosure.

At step 255, a 3D cache representing at least a portion of scene data associated with a scene is rendered, according to a set of camera specifications corresponding to the video output, to produce a frame sequence, where the 3D cache is computed using at least one 2D image of the scene. In an embodiment, the at least a portion of scene data is associated with a first observation of the scene at a first time and the video output is associated with a second observation of the scene at a second time.

In an embodiment, a first 2D image of the scene is unprojected according to a first camera capture specification to generate at least a portion of the scene data. In an embodiment, a second 2D image of the scene is unprojected according to a second camera capture specification to generate an additional portion of the scene data. In an embodiment, the scene is dynamic. In an embodiment, at least a portion of the scene data comprises LIDAR data. In an embodiment, the scene data comprises at least one of a colored point cloud, Gaussian splats, position coordinates, depth, color, or features. In an embodiment, the 3D cache is edited to modify at least one characteristic of the scene. In an embodiment, the at least one characteristic includes one or more of an object, color, depth, or position coordinates. In an embodiment, the set of camera specifications is provided by a user. In an embodiment, the set of camera specifications defines a camera path including at least one of a position, orientation, or focal length of the camera.

At step 260, a mask sequence associated with the set of camera specifications defining unobserved pixels in the frame sequence is generated. In an embodiment, the mask identifies missing or unobserved pixels in each rendered frame. In an embodiment, the mask sequence to is applied to the latent frame sequence (via element-wise multiplication), removing latent vectors corresponding to the missing regions in each latent frame, to produce a masked latent sequence.

At step 265, one or more frames in the frame sequence is encoded to produce a latent frame sequence. At step 270, the latent frame sequence and the mask sequence is processed to generate at least one video frame in the video output. In an embodiment, the processing further comprises applying the mask sequence to the latent frame sequence to produce a masked latent sequence. In an embodiment, the masked latent sequence is combined with Gaussian noise to produce a noised latent sequence, the noised latent sequence is denoised by a diffusion model to produce a denoised latent sequence, and the denoised latent sequence is decoded to generate the video output. In an embodiment, steps 255, 260, 265, and 270 are repeated using the at least one frame in the video output to generate at least one subsequent frame in the video output according to at least a second camera specification. In an embodiment, prior to repeating step 255, the 3D cache is augmented with additional scene data generated according to the second camera specification using the subsequent frame. In an embodiment, a reprojection error between depth estimations of the at least one frame and the subsequent frame are minimized to align the additional scene data.

In one or more embodiments, at least one of steps 255, 260, 265, or 270 is performed on a server or in a data center to generate the video output, and the video output is streamed to a user device. In one or more embodiments, at least one of steps 255, 260, 265, or 270 is performed within a cloud computing environment. In one or more embodiments, at least one of steps 255, 260, 265, or 270 is performed for training, testing, or certifying a neural network employed in a machine, robot, or autonomous vehicle. In one or more embodiments, at least one of steps 255, 260, 265, or 270 is performed on a virtual machine comprising a portion of a graphics processing unit. In one or more embodiments, at least one of steps 255, 260, 265, or 270 is implemented to include advanced error correction, fault-tolerance, and self-healing capabilities.

FIG. 2C illustrates a block diagram of an example training configuration 235, according to an embodiment. The training configuration 235 includes the video generator 150, the memory 135, and a loss function 275. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the training configuration 235 is within the scope and spirit of embodiments of the present disclosure.

The video diffusion model 220 is a general-purpose model that can be fine-tuned into customized world models for downstream applications. In an embodiment, the introduction of additional trainable parameters 245 for the video generator 150 is minimized as the pre-trained video diffusion model 220 has been trained on massive Internet data, any new parameters may not generalize as well. In an embodiment, parameters 245 used by the encoder 205 and decoder 230 are frozen (not changeable) during fine-tuning.

With the renderings of the 3D cache as the conditioning signal c, the modified video diffusion model 220

$${f}_{θ}^{′}$$

fine-tuned. In an embodiment, the training dataset 215 includes renderings of the 3D cache 240, [symbol] (P^{t,v},⋅) that are paired with corresponding RGB ground truth video x along a new camera trajectory (set of camera specifications). During fine-tuning, masked latent is concatenated with the noisy version z_{τ}=α_{τ}ε(x)+σ_{τ}ϵ of the target video x in latent space along the channel dimension, for input into the video diffusion model 220. The video diffusion model 220 processes the input according to the parameters 245 to generate a prediction.

The loss function 275 receives the prediction video generated by the video generator 150 and ground truth target video x and computes losses using an objective function. In an embodiment, the parameter updates are computed using the losses and the parameters 245 are updated via backpropagation. In an embodiment, the loss function 275 evaluates the denoising score matching objective function of equation (1), where the target y is z₀=ε(x) following the pre-trained image-to-video diffusion model practices. In an embodiment, the rendered frame is encoded using the CLIP model as an additional condition.

FIG. 3A illustrates a block diagram of an example multiple view input video generation system 300, according to an embodiment. The video generation system 300 comprises the memory 135, a rendering unit 325, an encoder 305, a fusion unit 350, a video diffusion model 320, and the decoder 230. In an embodiment, the video generator 150 comprises a pre-trained video foundation model, such as a diffusion model. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the video generation system 100 is within the scope and spirit of embodiments of the present disclosure.

In contrast with the video generation system 200 having scene data constructed from single views of static or dynamic scene data stored in the 3D cache 140, the video generation system 300 has scene data constructed from time-synchronized multiple views of static or dynamic scene data stored in the 3D cache 340. When conditioning the video diffusion model 320 with the renderings of the 3D cache 340, a key challenge is that the 3D cache 340 may be inconsistent across different camera viewpoints, either due to imperfect depth predictions or inconsistent lighting. Hence, the video diffusion model 320 needs to aggregate the information (if V>1) to generate a coherent video output. A conventional aggregation approach directly fuses point clouds in 3D space. While being simple, such an approach strongly relies on depth alignment and will introduce artifacts when inconsistencies manifest across multiple viewpoints. Furthermore, it would be nontrivial to imbue such fused point cloud with view dependent lighting information or to edit the fused point cloud to modify the scene.

The memory 335 stores the spatiotemporal 3D cache 340 that includes the scene data that is computed using time-synchronized multiple views. The memory 135 also stores parameters 345 for the pre-trained encoder 305, video diffusion model 320, and decoder 330. The rendering unit 325 renders the 3D cache 340 using the set of camera specifications for the output video to produce frame sequences and mask sequences. Specifically, frame and mask sequences are rendered for each view of the multiple views. In an embodiment, the rendering unit 325 performs the operations of the rendering unit 225. In an embodiment, the rendering unit 325 renders two or more frame and mask sequences in parallel. In one embodiment, for static scenes, at least V rendered images are produced for each output video frame using the elements of the scene data stored in the 3D cache 340 corresponding to an input capture specification that is closest to the output camera specification for the output video frame.

In an embodiment, for dynamic scenes, the elements of the scene data stored in the 3D cache 340 corresponding to the same time t (time-synchronized) are rendered using the output camera specification of each output video frame to produce V rendered images for each dynamic scene output video frame. In one embodiment, for dynamic scenes, only the static regions of the elements of the scene data stored in the 3D cache 340 are rendered after masking out dynamic regions. In another embodiment, for dynamic scenes, the elements of the scene data stored in the 3D cache 340 are aligned (synchronized) across time using scene flow prior to rendering.

The frame sequences are encoded by encoder 305 to produce latent frame sequences. In an embodiment, the coder 305 comprises one or more encoders 205. In an embodiment, the encoder 305 encodes two or more frame sequences in parallel.

The fusion unit 350 applies the corresponding mask to each latent frame sequence and then, in contrast with the single view processing, the latent frame sequences are combined to produce one fused latent sequence. In an embodiment, max pooling is applied to the time-synchronized masked latent frame sequences to produce the fused latent sequence. In an embodiment, time-synchronized frames in the latent frame sequences are concatenated to produce the fused latent sequence. Although concatenation empirically works well, it requires bounding the maximum number of viewpoints the model can support by a constant and imposes an order on the viewpoints. In contrast, max-pooling is a permutation-invariant fusion operation.

The fused latent sequence is combined (concatenated) with noise for processing by the video diffusion model 320, according to the parameters 345, to produce a denoised latent sequence. In an embodiment, the noise is Gaussian noise. In an embodiment, noise is added with each masked latent frame before fusing. In an embodiment, the video diffusion model 320 is the video diffusion model 220. The video diffusion model 320 may be fine-tuned using the training configuration 235 to determine the parameters 335.

Finally, the denoised latent sequence, video is decoded, according to the parameters 345, by the decoder 230 [symbol] to generate the video output \hat{x}= [symbol] (z) corresponding to the set of camera specifications. In an embodiment, the decoder 230 comprises a pre-trained VAE decoder. Fine-tuning and inference of the video diffusion model 220 are performed in the latent space. The pre-trained video diffusion model 220 is fine-tuned to process additional 3D conditioning or guidance input provided by the masked latent sequence. The video diffusion model 330 is able to remove artifacts resulting from the unobserved regions and generate a high-quality video output while maintaining 3D consistency.

FIG. 3B illustrates a block diagram of an example multiple view latent fusing unit 350, according to an embodiment. The fusion unit 350 comprises mask unit 310 and combine unit 315. In an embodiment, the mask unit 310 performs the operations of the mask unit 210 for two or more frame and mask sequences in parallel to produce masked latent sequences. As shown in FIG. 3B, the mask unit 310 receives time-synchronized latent frame sequences 351 and 352 and corresponding mask sequences 356 and 357, respectively.

In an embodiment, the masked latent sequences from multiple views are fused by separately processing each time-synchronized masked latent frame with added noise by the first layer of the video diffusion model 320, denoted by In-Layer, to produce layer-processed latent frames z^{v,t}. Then max-pooling is applied over all the time-synchronized layer-processed latent frames to produce the final feature map. In summary:

$${{z}^{v ,}}^{′} = In - Layer ( {z}^{v} ⊙ {{M}^{v ,}}^{′} ) , \qquad Eq . ( 4 )$$

$${z}^{′} = Max - Pool \{ {{z}^{1 ,}}^{′} , … , {{z}^{V ,}}^{′} \} \qquad Eq . ( 5 )$$

where ⊙ denotes element-wise multiplication and M^{v,t}∈ [symbol] ^{L×1×h×w}, is obtained by downsampling the M^{v} using minpooling with size

$$\frac{H}{h} \times \frac{W}{w} ,$$

in order to align with the latent dimension. The resulting feature map z′ is further processed in the video diffusion model 320 to generate a consistent video output that is conditioned on the renderings from the 3D cache 340. The fusion of masked frames in latent space enables smooth transitions between two disjoint views even if the depth estimates are misaligned and the lighting is different, while explicit fusion on the point cloud suffers from severe artifacts in misalignment regions.

In an embodiment, during fine-tuning, each time-synchronized masked latent frame is concatenated with the noisy version z_{τ}=α_{τ}ε(x)+σ_{τ}ϵ of the target (ground truth) video x in latent space, to produce layer-processed latent frames z^{v,t}. Then max-pooling is applied over all the time-synchronized layer-processed latent frames to produce the final feature map. In summary:

$${{z}^{v ,}}^{′} = In - Layer ( Concat ( {z}^{v} ⊙ {{M}^{v ,}}^{′} , {z}_{τ} ) ) . \qquad Eq . ( 6 )$$

FIG. 3C illustrates a flowchart of a method 370 for generating a video from multiple view inputs, according to an embodiment. Each block of method 370, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 370 is described, by way of example, with respect to the video generation systems 100 and 300 of FIGS. 1A and 3A, respectively. However, this method may additionally or alternatively be executed by any one system, or any combination of systems, including, but not limited to, those described herein. Furthermore, persons of ordinary skill in the art will understand that any system that performs method 370 is within the scope and spirit of embodiments of the present disclosure.

At step 375, a 3D cache representing at least a portion of scene data associated with a scene is rendered, according to a set of camera specifications corresponding to the video output, to produce frame sequences, where the 3D cache is computed using at least two 2D images of the scene. In an embodiment, the at least one portion of scene data is associated with a first observation of the scene at a first time and the video output is associated with a second observation of the scene at a second time. In an embodiment, the scene data is aligned across time using scene flow. In an embodiment, the rendering comprises, for each latent frame sequence, generating a mask sequence defining unobserved pixels in the frame sequence.

In an embodiment, time-synchronized 2D images of the scene associated with different camera capture specifications are unprojected to generate at least a portion of the scene data. In an embodiment, the portion of the scene data associated with the unprojected time-synchronized 2D images is duplicated for each video frame in the video output. In an embodiment, the scene is dynamic. In an embodiment, at least a portion of the scene data comprises LIDAR data. In an embodiment, the scene data comprises at least one of a colored point cloud, Gaussian splats, position coordinates, depth, color, or features. In an embodiment, the 3D cache is edited to modify at least one characteristic of the scene. In an embodiment, the at least one characteristic includes one or more of an object, color, depth, or position coordinates. In an embodiment, the set of camera specifications is provided by a user. In an embodiment, the set of camera specifications defines a camera path including at least one of a position, orientation, or focal length of the camera.

At step 380, one or more frames in the frame sequences is encoded to produce latent frame sequences. At step 385, two or more time-synchronized latent frames in the latent frame sequences are combined to produce a fused latent frame. In an embodiment, the combining comprises concatenating the two or more time-synchronized latent frames to produce the fused latent frame. In an embodiment, the combining comprises performing a max-pooling operation using the two or more time-synchronized latent frames to produce the fused latent frame. In an embodiment, before step 385, one or more frames in the frame sequences is encoded to produce a latent frame sequence. In an embodiment, the mask sequence to is applied to the latent frame sequence (via element-wise multiplication), removing latent vectors corresponding to the missing regions in each latent frame. At step 390, the fused latent frame sequence is processed to generate at least one video frame in the video output.

In an embodiment, each masked latent sequence is combined with Gaussian noise to produce a noised latent sequence, the noised latent sequence is denoised by a diffusion model to produce a denoised latent sequence, and the denoised latent sequence is decoded to generate the video output. In an embodiment, steps 375, 380, 385, or 390 are repeated using the at least one frame in the video output to generate at least one subsequent frame in the video output according to at least a second camera specification. In an embodiment, prior to repeating step 375, the 3D cache is augmented with additional scene data generated according to the second camera specification using the subsequent frame. In an embodiment, a reprojection error between depth estimations of the at least one frame and the subsequent frame are minimized to align the additional scene data.

In one or more embodiments, at least one of steps 375, 380, 385, or 390 is performed on a server or in a data center to generate the video output, and the video output is streamed to a user device. In one or more embodiments, at least one of steps 375, 380, 385, or 390 is performed within a cloud computing environment. In one or more embodiments, at least one of steps 375, 380, 385, or 390 is performed for training, testing, or certifying a neural network employed in a machine, robot, or autonomous vehicle. In one or more embodiments, at least one of steps 375, 380, 385, or 390 is performed on a virtual machine comprising a portion of a graphics processing unit. In one or more embodiments, at least one of steps 375, 380, 385, or 390 is implemented to include advanced error correction, fault-tolerance, and self-healing capabilities.

The video generation systems 100, 200, and 300 enable precise camera control for the generated video by constructing a 3D cache from seed image(s) or previously generated videos. The 3D cache is then rendered into 2D videos according to a camera path (set of camera specifications) that may be specified by a user to strongly condition the video generation, achieving more accurate camera control than conventional techniques. The video generation systems 100, 200, and/or 300 may perform sparse-view novel view synthesis, even in challenging settings such as driving scenes and monocular dynamic novel view synthesis. The video generation systems 100, 200, and 300 maintain 3D consistency and physics accuracy between the input image(s) and the output video and also between each successive frame in the output video.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

### Parallel Processing Architecture

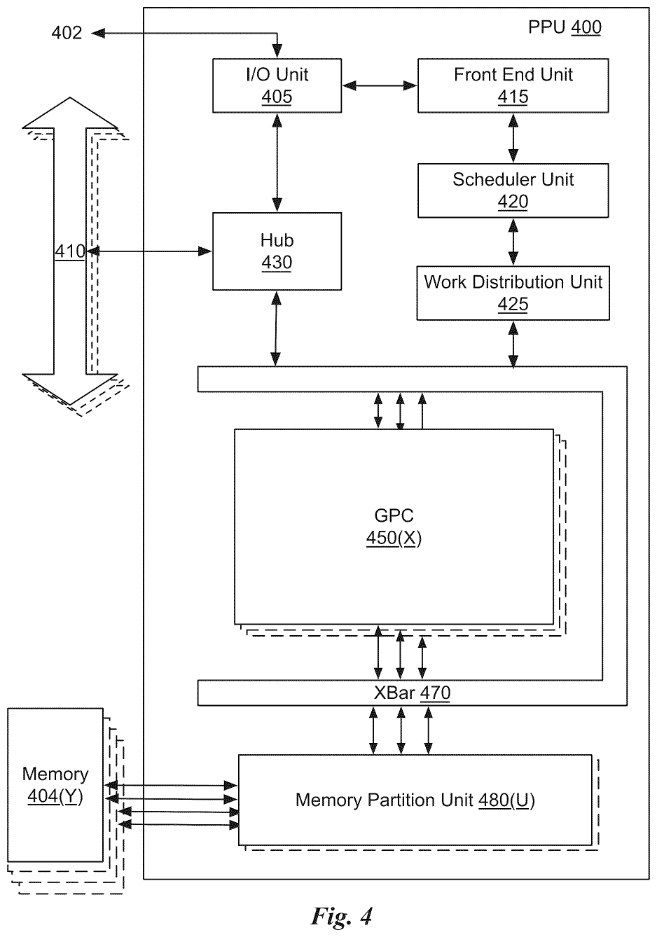

FIG. 4 illustrates a parallel processing unit (PPU) 400, in accordance with an embodiment. The PPU 400 may be used to implement one or more of the video generation systems 100, 200, or 300. The PPU 400 may be used to implement the training configuration 235. The PPU 400 may be used to implement one or more of the video generator 150, 3D cache unit 110, encoder 205, rendering unit 225, mask unit 210, video diffusion model 220, decoder 230, encoder 305, rendering unit 325, fusion unit 350, or video diffusion model 320.

In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

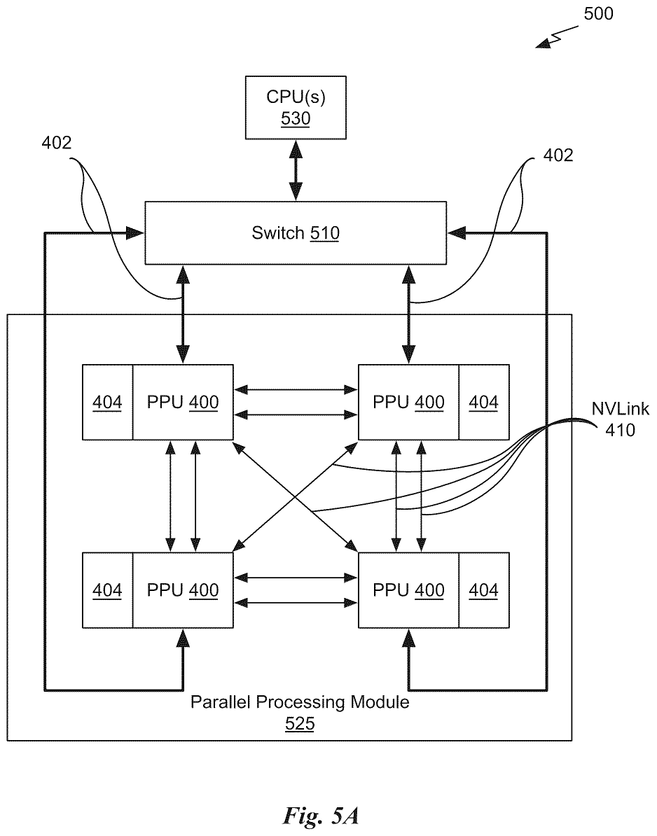

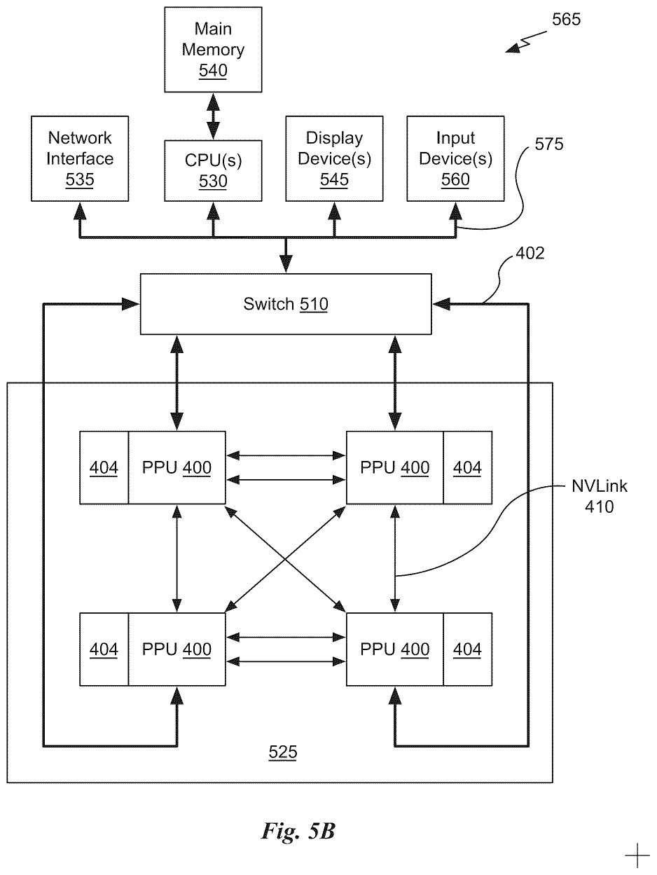

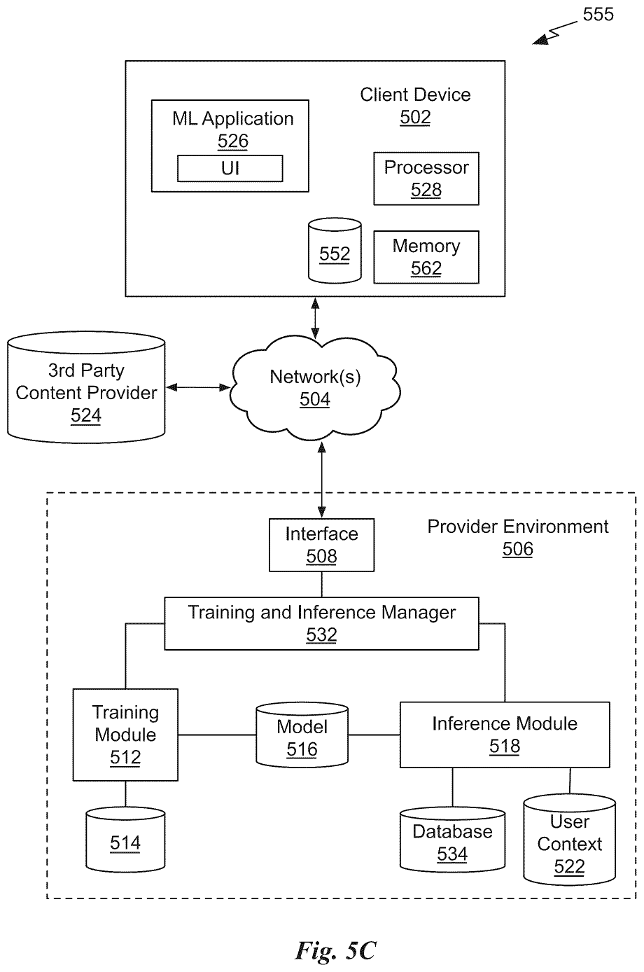

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the method 120, 250, and/or 370 shown in FIGS. 1C, 2B, and 3C, respectively. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the 250 shown in FIG. 3A. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network. In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

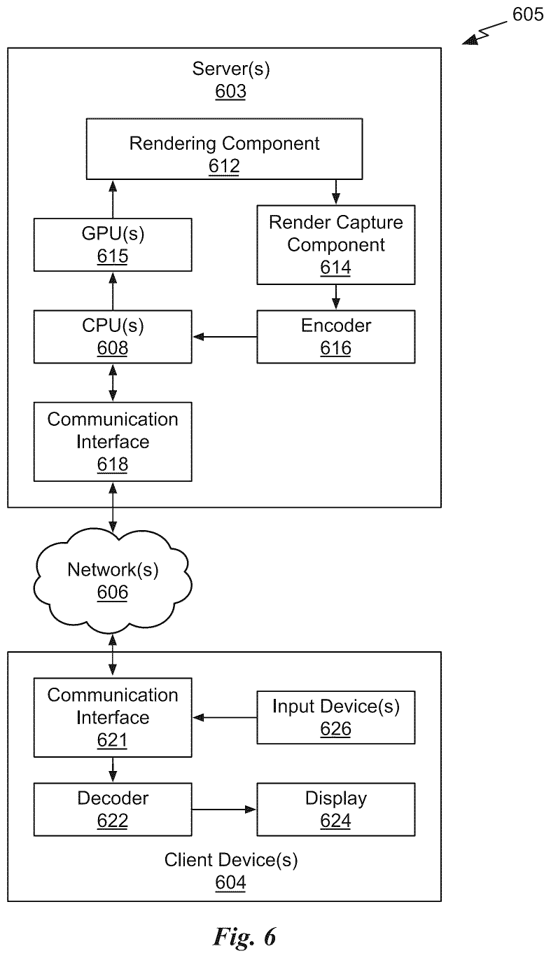

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method of generating video output, comprising:
rendering, according to a set of camera specifications corresponding to the video output, a three-dimensional (3D) cache representing at least a portion of scene data associated with a scene to produce a frame sequence, wherein the 3D cache is computed using at least one two-dimensional (2D) image of the scene;
generating a mask sequence associated with the set of camera specifications defining unobserved pixels;
encoding one or more frames in the frame sequence to produce a latent frame sequence; and
processing the latent frame sequence and the mask sequence to generate at least one video frame in the video output.

2. The method of claim 1, wherein the processing further comprises applying the mask sequence to the latent frame sequence to produce a masked latent sequence.

3. The method of claim 2, wherein the processing further comprises:
combining the masked latent sequence with Gaussian noise to produce a noised latent sequence;
denoising the noised latent sequence by a diffusion model to produce a denoised latent sequence; and
decoding the denoised latent sequence to generate the video output.

4. The method of claim 1, wherein the at least a portion of scene data is associated with a first observation of the scene at a first time and the video output is associated with a second observation of the scene at a second time.

5. The method of claim 1, wherein the rendering, generating, encoding, and processing are repeated using at least one frame in the video output to generate at least one subsequent frame in the video output according to at least a second camera specification.

6. The method of claim 5, wherein prior to repeating the rendering, the 3D cache is augmented with additional scene data generated according to the second camera specification using the subsequent frame.

7. The method of claim 5, further comprising minimizing a reprojection error between depth estimations of the at least one frame and the subsequent frame to align the additional scene data.

8. The method of claim 1, further comprising unprojecting a first 2D image of the scene according to a first camera capture specification to generate at least a portion of the scene data.

9. The method of claim 8, further comprising unprojecting a second 2D image of the scene according to a second camera capture specification to generate an additional portion of the scene data.

10. The method of claim 1, wherein at least a portion of the scene data comprises LIDAR data.

11. The method of claim 1, wherein the scene is dynamic.

12. The method of claim 1, wherein the scene data comprises at least one of a colored point cloud, Gaussian splats, position coordinates, depth, color, or features.

13. The method of claim 1, further comprising editing the 3D cache to modify at least one characteristic of the scene.

14. The method of claim 13, wherein the at least one characteristic includes one or more of an object, color, depth, or position coordinates.

15. The method of claim 1, wherein the set of camera specifications is provided by a user.

16. The method of claim 1, wherein the set of camera specifications defines a camera path including at least one of a position, orientation, or focal length of the camera.

17. The method of claim 1, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).

18. A video generation system, comprising:
a memory that stores a three-dimensional (3D) cache representing at least a portion of scene data associated with a scene, wherein the 3D cache is computed using at least one two-dimensional (2D) image of the scene; and
a video generator that generates a video output by:
rendering, according to a set of camera specifications corresponding to the video output, the 3D cache to produce a frame sequence;
generating a mask sequence associated with the set of camera specifications defining unobserved pixels;
encoding one or more frames in the frame sequence to produce a latent frame sequence; and
processing the latent frame sequence and the mask sequence to generate at least one video frame in the video output.

19. The video generation system of claim 18, wherein the processing further comprises applying the mask sequence to the latent frame sequence to produce a masked latent sequence.

20. A non-transitory computer-readable media storing computer instructions for generating video output that, when executed by one or more processors, cause the one or more processors to perform the steps of:
rendering, according to a set of camera specifications corresponding to the video output, a three-dimensional (3D) cache representing at least a portion of scene data associated with a scene to produce a frame sequence, wherein the 3D cache is computed using at least one two-dimensional (2D) image of the scene;
generating a mask sequence associated with the set of camera specifications defining unobserved pixels;
encoding one or more frames in the frame sequence to produce a latent frame sequence; and
processing the latent frame sequence and the mask sequence to generate at least one video frame in the video output.
